(19) United States
(12) Patent Application Publication
(10) Pub. No.: US 2015/0066728 A1
(43) Pub. Date: Mar. 5, 2015

(54) METHOD AND SYSTEM FOR MAKING PAYMENTS VIA A VALUE SYSTEM BASED UPON COMMODITY ASSETS

(71) Applicant: Aureus Ltd, Hong Kong S.A.R. (HK)

(72) Inventor: Graham Roger Newall, Teddington (GB)

(73) Assignee: AUREUS LTD, Hong Kong S.A.R. (HK)

(21) Appl. No.: 14/015,516

(22) Filed: Aug. 30, 2013

(51) Int. Cl. G06Q 40/04; G06Q 20/22

(52) U.S. Cl. CPC G06Q 40/04; G06Q 20/22
USPC 705/37

(57) ABSTRACT

The present disclosure provides a system for making payments via a value system based upon one or more commodity assets. The system includes an arrangement for maintaining one or more accounts in the value system, wherein the accounts have associated therewith one or more commodity assets, and an arrangement for diminishing or enhancing the one or more commodity assets associated with the one or more accounts in response to payments or receipts into the one or more accounts respectively. The system for making payments further includes an arrangement for using market makers for relating values of the one or more commodity assets to one or more monetary currencies employed for making the payments or receipts, wherein the market makers have external authorization outside a banking system.

### BACKGROUND

The present disclosure generally relates to financial transaction systems, and more specifically relates to systems for making payments through a value system based upon commodity assets, for example gold assets. Moreover, the present disclosure relates to method of making payments via a value system based upon commodity assets, for example gold assets. Furthermore, the present disclosure concerns software products recorded on machine-readable data storage media, wherein the software products are executable upon computing hardware for implementing the aforesaid methods of the disclosure.

Gold is a rare metal in nature; there are only circa 165,000 metric tons of gold available. On account of such rarity, a given weight of gold commands a high price in fiat currencies, such as the US dollar (US$) and the Euro, relative to other materials that are more abundant, for example copper. Traditionally, gold has been considered a safe and conservative investment, as it can be easily liquidated into aforesaid fiat currencies, and is acceptable generally throughout the world. In recent years, interest in investing in gold has grown dramatically worldwide, because investing in gold is prudent to insure against instability and risk in fiat currency systems. During a long-term period, and through both inflationary and deflationary periods, gold has consistently maintained its purchasing power. There is contemporarily a strong demand for gold all over the world, as its value tends to be more stable than fiat currencies, which can be diluted by quantitative easing and similar inflationary monetary policies, and other forms of investment such as stocks, real estate, equities and so forth, because a different set of socio-economic and cultural incentives drives gold markets worldwide in comparison to fiat currencies.

However, it is often contemporarily impractical to invest in gold, because a given investor has to ensure safety and security of his/her gold assets. Moreover, it is time consuming for the given investor to buy a quantity of gold, keep the quantity of gold safely and then sell the quantity of gold when there is an appreciation in gold prices. Furthermore, the given investor has to monitor continuously gold prices for benefiting optimally from his/her gold investment.

There does not presently exist a mechanism that facilitates investors to conduct their day-to-day transactions in correlation with changes in gold prices, without employing a known traditional method of buying, keeping and selling gold.

Therefore, there exists a need for a mechanism which facilitates people to conduct their day-to-day transactions, or appreciate their cash assets in correlation with the increase in gold prices, without utilizing traditional known methods of buying, keeping and selling the gold.

In recent decades, financial systems around the world have progressed away from fixing units of their fiat currencies to a defined constant quantity of gold, namely the “gold standard”, because use of fiat currencies permits governments to employ monetary policies, for example quantitative easing (QE), to stimulate their economies in periods of financial difficulty, for example in depression or recessions. However, such quantitative easing, namely “money printing”, dilutes already existing fiat currencies and reduces a purchasing power of a given unit of the fiat currencies. Moreover, the use of fiat currencies has enabled financial systems to be implemented in electronic form, wherein quantities of a given fiat currency can be transferred from one person to another merely by communicating data. However, discipline within fiat currency systems has more recently been lacking, resulting in a desire to utilize more secure forms of investment. However, such more secure forms of investment are impractical for day-to-day financial transactions, as aforementioned.

### SUMMARY

The present disclosure seeks to provide a system for making payments via a value system based upon one or more commodity assets, and a method of operating the same.

In one aspect, the present disclosure provides a method of operating a system for making payments via a value system based upon one or more commodity assets.

The method includes maintaining one or more accounts in the value system, wherein the accounts have associated therewith one or more commodity assets, diminishing or enhancing the one or more commodity assets associated with the one or more accounts in response to payments or receipts respectively into the one or more accounts respectively and using one or more market makers for relating values of the one or more commodity assets to one or more monetary currencies employed for making the payments or receipts, wherein the one or more market makers have external authorization outside a banking system.

The method is of advantage in that the one or more accounts are defined by a quantity of commodity assets, such that monetary values of the one or more accounts, expressed in one or more fiat currencies, temporally fluctuate, whilst enabling purchases and payments to occur from the one or more accounts digitally expressed in one or more fiat currencies; value in the accounts is maintained, even if the one or more fiat currencies experience dilution, for example hyperinflation, for example as occurred historically occurred in the Weimar Republic in circa year 1923.

The payments or receipts are conveniently made via use of one or more personal credit cards or debit cards in the value system, where the one or more personal credit cards or debit cards are useable in one or more ATM's (Automatic Transaction Machines) and/or one or more POS (Point of Sale) terminals. Moreover, the one or more personal credit cards or debit cards are beneficially RFID-enabled and/or chip-enabled for authentication purposes. Optionally, one or more personal payment bracelets, or similar user-wearable items, are employed as an alternative of addition to such one or more personal credit cards or debit cards for purposes of making payments in a fiat currency, for example in retailing premises for payment of day-to-day goods.

The one or more market makers are used in real time during the payments or receipts for relating values of the one or more monetary currencies, for example fiat currencies, to the one or more commodity assets.

The one or more commodity assets are implemented to include at least one of: base metals, minerals, noble metals Gold, Silver, rare Earth materials, hydrocarbon fuel products and/or raw materials.

The value system provides information to its one or more users associated with the one or more accounts, wherein the information includes an indication of the one or more commodity assets expressed in at least one of: weight, volume, numbers of physical elements, and a real-time monetary market value of the one or more commodity assets.

In another aspect, embodiments of the present disclosure provide a system for making payments via a value system based upon one or more commodity assets.

In yet another aspect, embodiments of the present disclosure provide a software product recorded on a non-transitory (non-transient) machine-readable data storage media, such that the software product is executable upon computing hardware for implementing the method of operating a system for making payments via a value system based upon one or more commodity assets.

Embodiments of the present disclosure facilitate users to purchase commodity assets such as gold without actually possessing them, to receive a debit/credit card holding a currency equivalent, for example fiat currency equivalent, balance corresponding to the purchased commodity assets, and make payments or withdraw cash in multiple currencies, for example multiple fiat currencies, using the debit/credit card. The debit/credit card is particularly useful for people who travel across multiple countries, but do not want to carry large amounts of cash with them. The present invention generally facilitates people to conduct their day-to-day transactions or appreciate their cash assets in correlation with the increase in asset value prices, for example gold prices, without worrying about the physical safety of their assets, for example gold, or without following the traditional method of buying, keeping and selling gold which is often cumbersome and impractical.

Additional aspects, advantages, features and objects of the present disclosure would be made apparent from the drawings and the detailed description of the illustrative embodiments construed in conjunction with the appended claims that follow.

It will be appreciated that features of the invention are susceptible to being combined in various combinations without departing from the scope of the invention as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the invention is not limited to specific methods and instrumentalities disclosed herein. Moreover, those in the art will understand that the drawings are not to scale. Wherever possible, like elements have been indicated by identical numbers.

FIG. 1 is an illustration of a value system that is suitable for practicing various implementations of the present disclosure;

FIG. 2 is an illustration of steps of a method for purchasing commodity assets in the value system, in accordance with the present disclosure;

FIG. 3A and FIG. 3B are an illustration of steps of a method for making payments in the value system via use of a personal credit card or debit card, in accordance with the present disclosure;

FIG. 4 is an illustration of steps of a method for purchasing and selling commodity assets by a market maker, in accordance with an embodiment of the present disclosure; and

FIG. 5 is an illustration of steps of operating the system for making payments via a value system based upon or more commodity assets, in accordance with the present disclosure.

### DETAILED DESCRIPTION OF ILLUSTRATIVE EMBODIMENTS

In the following detailed description, there are described illustrative embodiments of the disclosure and ways in which they can be implemented. Although the best mode of carrying out the invention has been disclosed, those in the art would recognize that other embodiments for carrying out or practicing the invention are also possible.

In overview, the present disclosure is concerned with a system for making payments via a value system based upon one or more commodity assets. The system includes an arrangement for maintaining one or more accounts in the value system, wherein the accounts have associated therewith one or more commodity assets, and an arrangement for diminishing or enhancing the one or more commodity assets associated with the one or more accounts in response to payments from or receipts into the one or more accounts respectively. The system for making payments further includes an arrangement for using market makers for relating values of the one or more commodity assets to one or more monetary currencies employed for making the payments or receipts, wherein the market makers have external authorization outside a banking system. The present disclosure thus provides an alternative system, which is capable of co-existing with existing known banking systems, or beneficially replacing known banking systems.

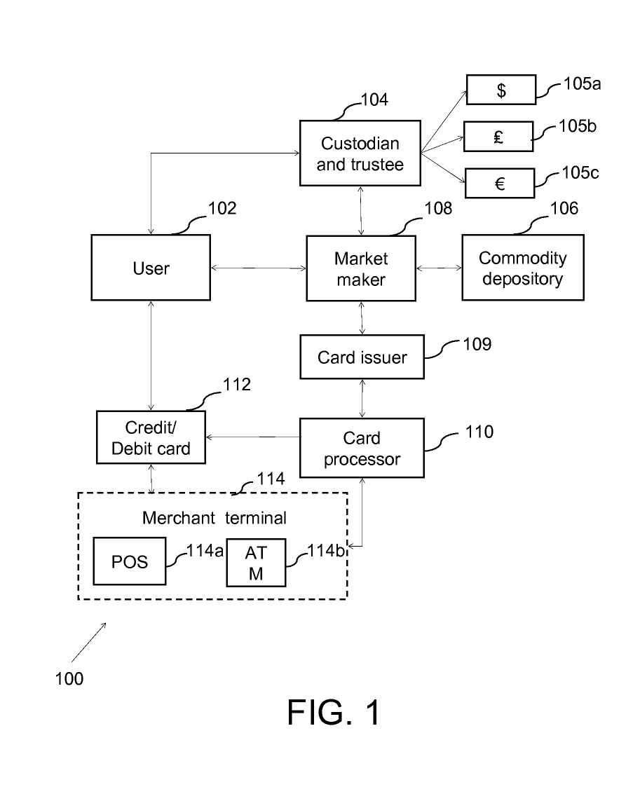

Referring now to the drawings, particularly by their reference numbers, FIG. 1 is an illustration of a value system indicated generally by 100 that is suitable for practicing various implementations of the present disclosure. The value system 100 includes a user 102, a custodian and trustee 104, segregated bank accounts 105a, 105b and 105c, a commodity depository 106, a market maker 108, a card issuer 109, a card processor 110, a debit/credit card 112, and a merchant terminal 114. The value system 100 is beneficially implemented using various technical apparatus, for example computing apparatus and one or more data communication networks which mutually interact in a manner that is hitherto not known.

The user 102 may be an individual, a corporate entity, a non-profit organization, or the like. Moreover, the custodian and trustee 104 may be a global financial institution that manages segregated bank accounts 105a, 105b and 105c of the user 102 in multiple jurisdictions around the world. In an exemplary embodiment, the custodian and trustee 104 may be Commercial Trust Ltd. (Hong Kong) that holds user funds in multiple segregated accounts 105a, 105b and 105c with an International bank such as HSBC, which currently operates in monetary currencies, namely fiat currencies, such as US dollar (USD), Hong Kong dollar (HKD), Great British Pound (GBP), Australian dollar (AUD), Canadian dollar (CAD), Swiss franc (CHF), Japanese yen (JPY), New Zealand dollar (NZD), Thai Baht (THB), Singapore dollar (SGD), Euro (EUR), and Chinese Yuan Renminbi (CNY).

In one embodiment, the user 102 may hold a bank account 105a, but does not qualify for receiving a debit/credit card corresponding to the bank account 105a. In another embodiment, the user 102 may not have a bank account in a particular jurisdiction, but does not wish to carry large amount of cash while travelling to that jurisdiction.

The commodity depository 106 facilitates supply and storage of one or more commodity assets, examples of which include, but are not limited to, base metals, minerals, noble metals, Gold, Silver, rare earth materials, hydrocarbon fuel products and/or raw materials. In an exemplary embodiment, the commodity depository 106 includes a network of Bullion Vault Member (LBMA), Vault London/Zurich/Singapore and Commercial Trust Ltd. Gold custodian for facilitating a supply and storage of gold.

The market maker 108 is a third (3^{rd}) party service provider and a non-banking institution that establishes a relationship with the user 102, the custodian and trustee 104, the commodity depository 106, and the card issuer 109, and enables substantially instantaneous selling and purchasing of the commodity assets at current market prices, independent of the conventional banking system, which employ monetary values, namely fiat currency values. In an embodiment, the market maker 108 holds a first share of commodity assets from the commodity depository 106 while the first share is safely deposited in the commodity depository 106 itself. The market maker 108 enables the user 102 to purchase a second share of commodity assets from the first share of commodity assets, while the second share is safely deposited in the commodity depository 106 itself. Both the user 102 and the market maker 108 do not receive physical possession of the commodity assets due to the costs and risks associated with logistics, transportation, and handling the commodity assets outside of a secured vault. For ensuring integrity of the system 100, activities of the market maker 108 are recorded and audited by an independent auditing party (not shown); in an event that the market maker 108 is not of adequate standard, the system 100 can be reconfigured to employ an alternative market maker 108.

In an embodiment, the custodian and trustee 104 manages transfer of funds to the market maker 108 for purchasing the second share of commodity assets. The market maker 108 keeps a record of the weight, volume, numbers of physical elements and a real-time monetary market value of the commodity assets in one or more monetary currencies, for example fiat currencies, and constantly updates the user 102 regarding fluctuations in equivalent currency balance of their second share based on fluctuations in price of the underlying commodity assets.

The market maker 108 further enables the card issuer 109 to issue a credit/debit card 112 to the user 102, wherein the credit/debit card 112 provides access to the equivalent currency balance corresponding to the second share of the commodity assets in the depository 106. The credit/debit card 112 is a multi-currency card that can be used in various Point of Sale (POS) terminals 114a and ATM 114b across multiple jurisdictions. In an exemplary embodiment, the card issuer 109 may be a member of the Card Associations which include well-known contemporary products such as MasterCard, Visa, Diners Club, Discover card, American Express, China Union Pay and Japan Credit card Bureau (JCB) and the credit/debit card 112 can be used at, for example, 2,300,000 ATMs worldwide to withdraw cash in local monetary currency, namely fiat currency, or used to purchase goods and services wherever the Card Association's card is accepted.

When the user 102 present their card 112 at the merchant terminal 114 for executing a transaction, the merchant terminal 114 sends an authorization request to the card issuer 109 by way of the card processor 110, which in turn sends an authorization request to the market maker 108. The market maker 108 checks whether or not the equivalent currency balance available in respect of the card 112 is sufficient to cover the transaction. The available equivalent currency balance is instantly evaluated based on amount of the commodity assets allocated to the user and current market prices of the commodity assets. When the equivalent currency balance associated with the card 112 is sufficient to cover the transaction, the market maker 108 communicates the same to the card issuer 109, updates the equivalent currency balance available to the card 112 and also updates the reduced amount/share of commodity assets corresponding to the updated equivalent currency balance. The card issuer 109 then sends the authorization response to the merchant terminal 114 by way of the card processor 110, which in turn completes the transaction in substantially real time, for example within a few milliseconds. In various embodiments, the card processor 110 provides a link between the global POS/ATM network and the card issuer 109. The card processor 110 provides transaction approval from the market maker 108 and settlement information to the card issuer 109 that receives the settlement funds from the market maker 108.

In an embodiment, the market maker 108 periodically transfers funds to the card issuer 109 to enable the card issuer 109 to carry out transactions pertaining to the credit/debit card 112. In an example, the market maker 108 may set a daily maximum limit of funds to be transferred to the card issuer 109. Thus, the market maker 108 provides an authorization to the card processor 109, and also transfer funds thereto for completing the transaction, as compared to conventional systems of authorization and funds transfer by a bank. The ATMs 114b are optionally a part of a conventional banking system, but when the user 102 accesses them using the card 112, they send an authorization request to the market maker 108, namely an entity external to the conventional banking system, instead of sending the authorization request to a corresponding card issuer; the conventional banking system receives funds from the market maker 108 to settle the transaction. Thus, the market maker 108 totally bypasses the conventional banks' authorization process enabling the user 102 to make purchases or withdraw cash at the merchant terminals 114. In a way, the market maker 108 solves the problems encountered with using the conventional banking system, such as commodity values being rigged in favor of the banks, and commodity values provided by the banks not being updated in real time, which can result in accounting errors, leading to favor of banks and to a disadvantage of users.

In FIG. 1, there is merely shown an example, which should not unduly limit the scope of the claims herein. One of ordinary skill in the art would recognize many variations, alternatives, and modifications of embodiments herein.

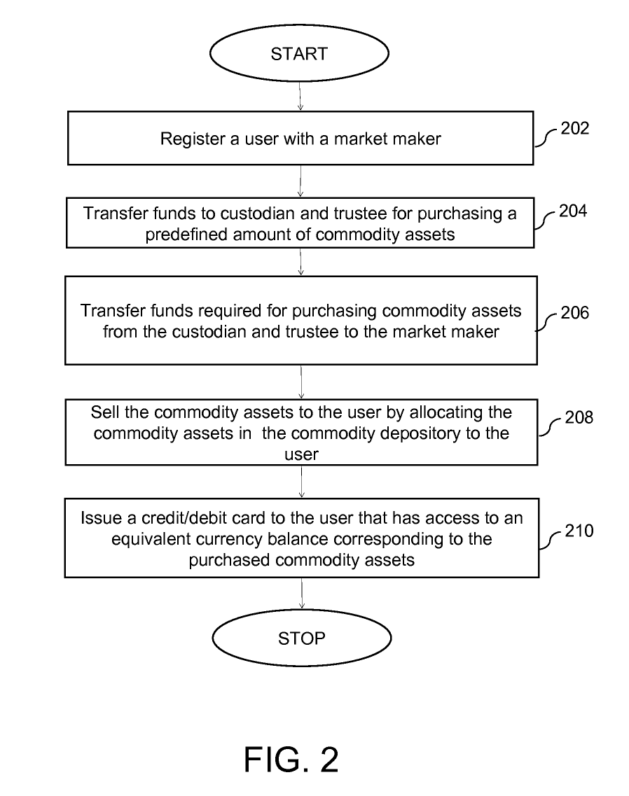

FIG. 2 is an illustration of steps of a method of purchasing commodity assets in the value system 100, in accordance with the present disclosure. The method is depicted as a collection of steps in a logical flow diagram, which represents a sequence of steps that can be implemented in hardware, software, or a combination thereof.

At a step 202, the user 102 may register themselves with the market maker 108. In an embodiment, the user 102 may register themselves online on a secure website of the market maker 108, where the user 102 may purchase and sell one or more commodity assets, check the real time monetary value of purchased commodity assets in multiple currencies, receive automated text and email alerts, receive income statements, and so forth. At a step 204, the user may transfer funds to the custodian and trustee 104 for purchasing a first amount of commodity assets from the market maker 108. In an embodiment, the funds may be added in a variety of ways, namely physical means such as cash or check, and electronic means such as wire transfer from another account.

At a step 206, the funds may be transferred from the custodian and trustee 104 to the market maker 108 for purchasing the first amount of commodity assets, where the market maker 108 operates in a default fiat currency such as US dollar (US$, USD). In an embodiment, the market maker 108 may specify a minimum amount of commodity assets that a user must buy to complete the purchase. The amount of funds required for purchasing the first amount of commodity assets may be calculated based on Equation 1 (Eq. 1):

R_{F}=A_{CA}U_{P}FX_{M}M_{MM} Eq. 1

wherein
R_{F}=Requisite funds;
A_{CA}=Amount of commodity asset;
FX_{M}=FX margin;
M_{MM}=Margin of the market maker 108; and
wherein the FX margin is currency conversion fees to the default currency, and the margin of the market maker 108 corresponds to the service fees of the market maker 108.

In an example, if the user 102 wants to purchase 10 grams of gold using their fiat currency in a form of British Pounds (GBP), then the funds required to be transferred to the market maker 108 would be sum of real-time monetary value of 10 grams of gold, currency conversion fees from GBP to USD, and service fees of the market maker 108.

At a step 208, the market maker 108 sells the first amount of commodity assets to the user 102 by allocating a share of commodity assets in the commodity depository 106 to the user 102. In an embodiment, the market maker 108 allocates a share of commodity assets to the user 102 from their share of commodity assets in the commodity depository 106. After the market maker 108 allocates the first amount of commodity assets to the user 102, a confirmation alert may be sent to the user 102 through SMS and/or email, wherein the confirmation includes the amount and current market value of the purchased commodity assets.

In an embodiment, the market maker 108 maintains one or more conversion tables to create/update an equivalent currency balance, for example fiat current balance, corresponding to the commodity assets allocated to the user, and constantly updates the user 102 regarding any fluctuations in the equivalent currency balance based on the fluctuations in the market prices of the underlying commodity assets.

Finally, at a step 210, the market maker 108 enables the card issuer 109 to issue a credit/debit card 112 to the user, where the credit/debit card 112 enables access to an equivalent currency balance, for example fiat currency balance, corresponding to the commodity assets purchased by the user 102; in other words, the card technically is unfunded until the one or more commodity assets are bought by the one or more market makers 108; however, the one or more market makers maintains a float of funds at the issuer to ensure that the user 102 is accommodated, namely “covered”, although the float of funds is optionally subject to daily withdrawal limits set by the card issuer, or the one or more market makers 108. In other words, the card technically is unfunded until the asset is bought by the market maker; however, the market maker maintains a float at the issuer to ensure that the customer is covered this may be subject to daily withdrawal limits set by the issuer or market maker.

In an embodiment, the equivalent currency balance available to the credit/debit card 112 may fluctuate based on the fluctuations in the market prices of the underlying commodity assets. In general, fiat currencies have a tendency to inflate, as a result of more fiat currency being generated by associated governments, for example as a consequence of quantitative easing to stimulate economic growth, and the fluctuations tend to work in favor of the user by increasing the value of the user's allocated commodity assets expressed in the fiat currency.

In an exemplary embodiment, if the value of commodity asset such as gold allocated to the user is $2,000 USD, then user can access an equivalent currency balance of approximately $2,000 USD through their debit/credit card 112. If the value of gold increases to $2,100.00, then the equivalent currency balance will increase to approximately $2,100.00 USD. Conversely, if the value of gold bullion decreases to $1900.00 USD, the equivalent currency balance will decrease to approximately $1900.00 USD. Thus, the user 102 can take advantage of, and be exposed to, the fluctuations in the market prices of the commodity assets.

FIG. 2 is merely an example, which should not unduly limit the scope of the claims herein. One of ordinary skill in the art would recognize many variations, alternatives, and modifications of embodiments herein.

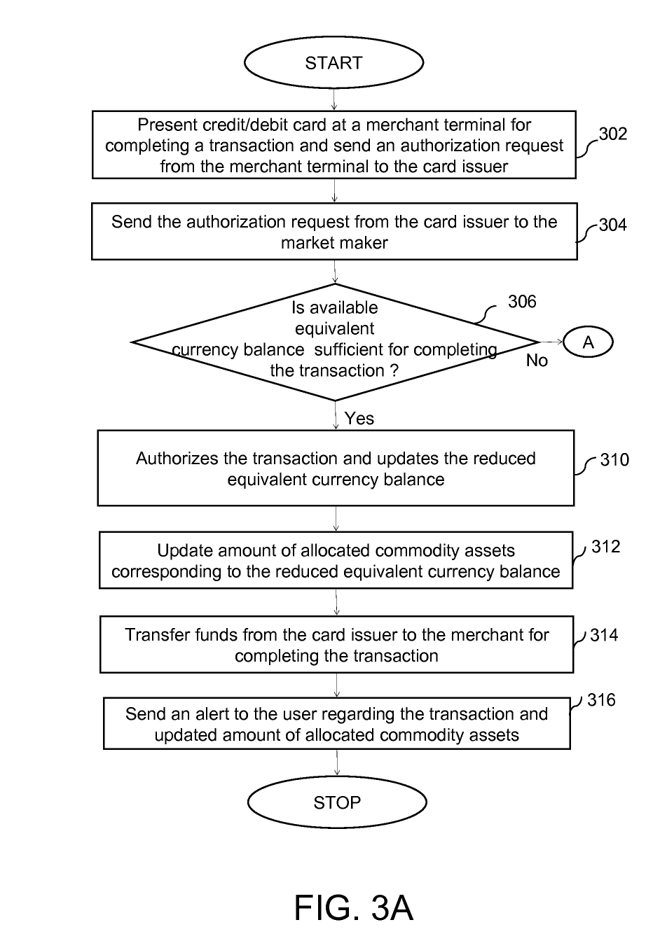

FIG. 3 is an illustration of steps of a method for making payments in the value system 100 via use of the personal credit/debit card 112, in accordance with the present disclosure. The method is depicted as a collection of steps in a logical flow diagram, which represents a sequence of steps that can be implemented in hardware, software, or a combination thereof.

At a step 302, the credit/debit card 112 is presented by the user at the merchant terminal 114 for completing a transaction. The merchant terminal 114 may be a POS terminal 114a that facilitates purchase of goods/services or an ATM 114b that facilitates withdrawal of cash. Upon receiving the transaction request, the merchant terminal 114 sends an authorization request to the card issuer 109 by way of the card processor 110 for completing the transaction. The authorization request may include details such as credit/debit card number, the transaction amount, and/or a merchant identifier.

At a step 304, the authorization request is sent from the card issuer 109 to the market maker 108, as compared to conventional systems where the authorization request is sent from the card issuer 109 to a bank of the user 102. The market maker 108, an entity external to the conventional banking system enables the user 102 to instantly sell and purchase commodity assets without intervention of their banks

At a step 306, the market maker 108 checks whether or not the available equivalent currency balance to the card 112 is sufficient to complete the transaction. The market maker 108 maintains one or more conversion tables to compute a real-time monetary value, namely fiat currency value, of one or more commodity assets in different currencies. In an exemplary embodiment, when the commodity assets are gold, the market maker 108 calculates the available equivalent currency balance using the following Equation 2 (Eq. 2):

A_{CEB}=G_{gb}GₚFX_{M}M_{AGM}GM_{MM} Eq. 2

wherein
A_{CEB}=Available currency equivalent balance;
G_{gb}=Gold grams balance;
Gₚ=Gold price, namely current unit price of gold;
FX_{M}=FX margin (if any);
GM_{MM}=Gold margin of market maker 108; and
wherein
the Gold grams balance is a weight of gold allocated to the user 102 in the commodity depository 106; and
the FX margin is currency conversion fees when the currency, namely fiat currency, of the merchant terminal 114 is other than USD, namely a default currency of the market maker 108. However, it is to be appreciated that decline in the “petrodollar” as a result of “peak oil” may result in other fiat currencies becoming dominant in the world in future, such that another fiat currency other than USD is optionally employed.
The maximum anticipated gold movement represents a daily transaction limit of the card 112, and the gold margin of the market maker 108 represents a service fees charged by the market maker 108 for completing the transaction.

In an example, if the user 102 wants to withdraw cash in GBP from an ATM 114b, then the available equivalent currency balance in the card 112 would be sum of real-time monetary value of available gold, currency conversion fees from GBP to USD and service fees of the market maker 108.

At a step 308, the transaction is denied by the market maker 108 if the available currency equivalent balance is not sufficient to cover the transaction amount, and an alert is sent to the user by way of a communication, for example an SMS and/or email.

At a step 310, the transaction is authorized by the market maker 108 if the available currency equivalent balance is sufficient to cover the transaction amount, and an authorization response is then sent to the card issuer 109, which forwards the response to the card processor 110. The market maker 108 instantly debits the transaction amount from the available equivalent currency balance of the card 112 and updates the reduced equivalent currency balance. The card processor 110 forwards the authorization response to the merchant terminal 114, which in turn completes the transaction.

At a step 312, the amount of commodity assets remaining with the user 102 is updated based on the reduced equivalent currency balance and the current market price of the underlying commodity asset. The amount of commodity assets allocated to the user 102 reduces with each transaction of the credit/debit card 112. Thus, the user 102 sells the underlying commodity assets to the market maker 108 in exchange of purchased goods/services or cash; “cash” in such case is, for example, in a fiat currency.

At a step 314, the funds are transferred from the card issuer 109 to the merchant 114 for completing the transaction. In an embodiment, the market maker 108 periodically transfers a predefined amount of funds to the card issuer 109 so that the card processor 110 can instantly authorize the transaction upon receiving a transaction request from the debit/credit card 112 and the card issuer 109 can settle the transaction to the merchant terminal 114.

Finally at a step 316, an alert is sent to the user 102 by the market maker 108, where the alert may include details such as updated amount of allocated commodity assets, real-time monetary value of the commodity assets, details of transaction of the card 112, and so forth. The user 102 may receive the alerts through various communicating means, for example e-mail messages, text and multimedia messages, automated phone calls, facsimile, updates on the market maker's website.

In various embodiments of the present invention, the market maker 108 takes a revenue share in all transactions related to the purchase and sale of commodity assets, currency conversions and the use of the debit/credit card 112. Moreover, the market maker 108 may charge a monthly administration fees, storage and insurance fees from the user 102.

It should be noted here that the steps 302 to 316 are only illustrative and other alternatives can also be provided where one or more steps are added, one or more steps are removed, or one or more steps are provided in a different sequence without departing from the scope of the claims herein.

FIG. 3 is merely an example, which should not unduly limit the scope of the claims herein. One of ordinary skill in the art would recognize many variations, alternatives, and modifications of embodiments herein.

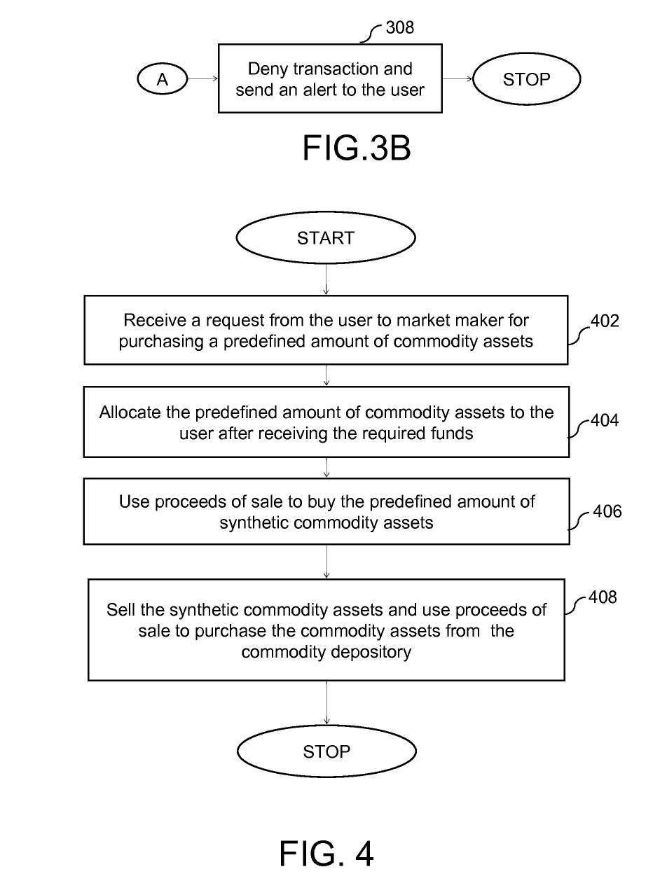

FIG. 4 is an illustration of steps of facilitating purchase and sell of commodity assets by the market maker 108, in accordance with an embodiment of the present disclosure. The method is depicted as a collection of steps in a logical flow diagram, which represents a sequence of steps that can be implemented in hardware, software, or a combination thereof.

At a step 402, a request is received by the market maker 108 from the user 102 to purchase a first amount of commodity assets. In an embodiment, the market maker 108 holds a first share of commodity assets in the commodity depository 106 and enables the user 102 to purchase the first amount of commodity assets from the first share of commodity assets itself. At a step 404, the first amount of commodity assets are allocated to the user 102 after the market maker 108 receives the requisite funds from the user 102. The requisite funds may be calculated based on Equation 1 (Eq. 1). In an exemplary embodiment, the market maker 108 may hold 1-2 LBMA gold bars weighing 12.4 kg or 400 oz. each valued at circa $545,000 in the commodity depository 106 and allocates the first amount of gold such as 100 grams of gold to the user 102 upon receiving the requisite funds. Although the gold bars remain intact, there system 100 enables ownership rights of a portion of a given gold bar to be established, wherein the ownership rights are relinquished as the user 102 makes purchases and payments in monetary currencies, namely fiat currencies.

At a step 406, the proceeds of sale may be used by the market maker 108 to buy the first amount of synthetic commodity assets. In an exemplary embodiment, the market maker 108 may use the proceeds of sale of 100 grams of gold to purchase 100 grams of synthetic gold from a synthetic gold liquidity provider to hedge physical gold purchase with synthetic gold.

At a step 408, the synthetic commodity assets may be sold by the market maker 108 when the first share of commodity assets held by the market maker 108 drops down to a predefined minimum value and use the proceeds of sale to replenish their stock of the commodity assets. In an exemplary embodiment, when the gold held by the market maker 108 reduces to an equivalent bar denomination, then synthetic gold held by the market maker 108 is sold to buy LBMA gold bars. The buying of the synthetic gold and then selling after some time minimizes the losses due to price fluctuations in the LBMA gold bars. However, it will be appreciated that, during periods of high volatility in hedged synthetic gold, for example in an event of a stock market crash event, for example as occurred in Wall Street in the 1920's, the system 100 can optionally revert back to utilizing only real physical commodity assets, for example real physical gold.

In another embodiment, the proceeds of sale of synthetic commodity assets may be used by the market maker 108 to transfer funds to the card issuer 109 to enable them to settle transactions pertaining to the debit/credit card 112.

It should be noted here that the steps 402 to 408 are only illustrative and other alternatives can also be provided where one or more steps are added, one or more steps are removed, or one or more steps are provided in a different sequence without departing from the scope of the claims herein.

FIG. 4 is merely an example, which should not unduly limit the scope of the claims herein. One of ordinary skill in the art would recognize many variations, alternatives, and modifications of embodiments herein.

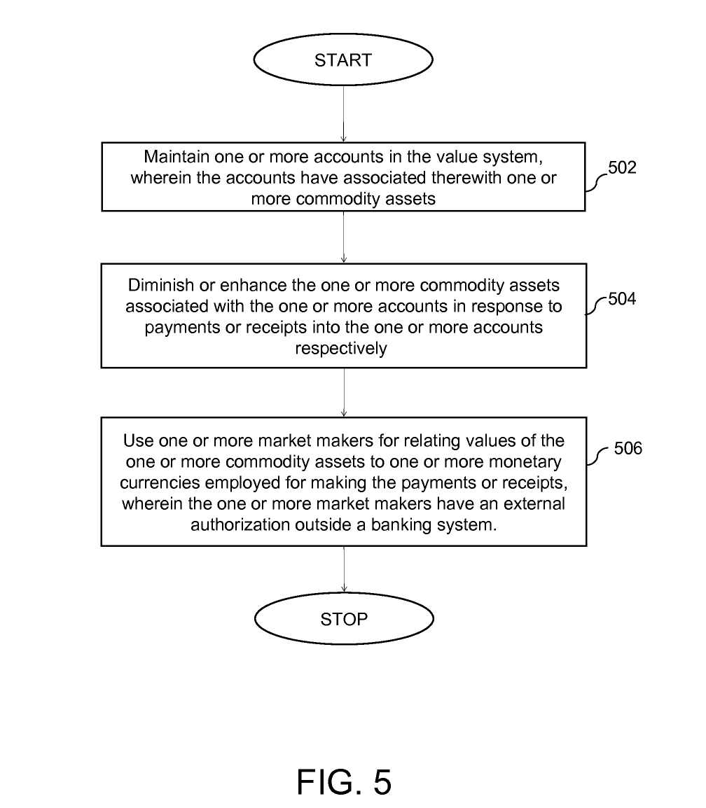

FIG. 5 is an illustration of steps of operating the system for making payments via the value system 100 based upon or more commodity assets, in accordance with the present disclosure. The method is depicted as a collection of steps in a logical flow diagram, which represents a sequence of steps that can be implemented in hardware, software, or a combination thereof.

At a step 502, one or more accounts are maintained in the value system 100, wherein the accounts have associated therewith one or more commodity assets. At a step 504, the one or more commodity assets associated with the one or more accounts are diminished or enhanced in response to payments or receipts into the one or more accounts respectively. At a step 506, one or more market makers 108 are used for relating values of the one or more commodity assets to one or more monetary currencies, for example fiat currencies, employed for making the payments or receipts, wherein the one or more market makers 108 have external authorization outside a banking system. As aforementioned, the one or more market makers 108 are beneficially externally audited by one or more independent auditing parties to ensure integrity and robustness of the value system 100 against fraud or corrupt influences.

It should be noted here that the steps 502 to 506 are only illustrative and other alternatives can also be provided where one or more steps are added, one or more steps are removed, or one or more steps are provided in a different sequence without departing from the scope of the claims herein.

From the foregoing, it will be appreciated that the authorization of gold transactions, via the one or more market makers 108, occurs externally to conventional banking systems. Such conventional banking systems are vulnerable to collapse, for example arising from employing excessive leverage on financial transactions executed in fiat currencies, and from governmental policies that are highly inflationary in nature, for example excessive quantitative easing executed for political purposes for trying to create short-term economic growth, for example immediately prior to a general election and/or presidential election. Thus, the system 100 is capable of preserving value for its user 102, even if conventional banking systems experience systemic problems, for example a stock market crash. Moreover, the system 100 is also capable of being robust to runs on monetary currencies, namely fiat currencies.

Unlike a conventional known banking system, the system 100 does not directly have any monetary allocation to a credit card or debit card of the user 102, but links a credit card or debit card compatible with the system 100 to one or more commodity assets, namely elements which cannot simply by inflated in a manner of a fiat currency. Moreover, the system 100 is capable of supporting multiple currency bins for use by the user 102. Furthermore, the user 102 is able to employ external authorization for a credit card or debit card for use with the system 100 a party responsible for managing operation of the system. Payment in association with the system 100 can be made by employing one or more of: mobile telephones, smart phones, RFID-enabled apparatus, electronic integrated circuits, software applications, bracelets, and biologically-implanted electronic chip modules. The system 100 maintains a record of the identity of the user 102, and is optionally operable to block transaction in association with the user 102 if the user 102 appears to be acting out-of-character, for example the credit card or debit card of the user 102 is stolen and an attempt by an authorized party made to use the stolen credit card or debit card.

Although embodiments of the present invention have been described comprehensively in the foregoing, in considerable detail to elucidate the possible aspects, those skilled in the art would recognize that other versions of the invention are also possible.

1. A method of operating a system for making payments via a value system based upon one or more commodity assets, wherein the method includes:
(a) maintaining one or more accounts in the value system, wherein the accounts have associated therewith one or more commodity assets;
(b) diminishing or enhancing the one or more commodity assets associated with the one or more accounts in response to payments or receipts respectively into the one or more accounts respectively;
wherein the method further includes:
(c) using one or more market makers for relating values of the one or more commodity assets to one or more monetary currencies employed for making the payments or receipts, wherein the one or more market makers have external authorization outside a banking system.

2. The method as claimed in claim 1, wherein the method comprises:
(d) arranging for the one or more commodity assets to include one or more real physical materials; and
(e) implementing the payments or receipts in one or more fiat currencies.

3. The method as claimed in claim 1, wherein the method includes:
(f) in the value system, making the payments or receipts via use of a personal credit card or debit card.

4. The method as claimed in claim 3, wherein the method includes:
(g) arranging for the system to support use of the personal credit card or debit card, wherein the personal credit card or debit card is RFID-enabled and/or chip-enabled for authentication purposes.

5. The method as claimed in claim 4, wherein the method includes:
(h) arranging for the personal credit card or debit card to be useable in one or more ATM's and/or one or more POS terminals.

6. The method as claimed in claim 1, wherein the method includes using the one or more market makers in real time when implementing the payments or receipts for relating values of the one or more monetary currencies to the one or more commodity assets.

7. The method as claimed in claim 1, wherein the method includes implementing the one or more commodity assets to include at least one of: base metals, minerals, noble metals Gold, Silver, rare Earth materials, hydrocarbon fuel products and/or raw materials.

8. The method as claimed in claim 1, wherein the method includes arranging for the value system to provide information to its one or more users associated with the one or more accounts, wherein the information includes an indication of the one or more commodity assets expressed in at least one of: weight, volume, numbers of physical elements, a real-time monetary market value of the one or more commodity assets.

9. The method as claimed in claim 1, wherein the method includes auditing transactions executed by the one or more market makers by employing an independent auditing means.

10. A software product recorded on non-transitory machine-readable data storage medium, wherein the software product is executable upon computing hardware for implementing the method as claimed in claim 1.

11. A system for making payments via a value system based upon one or more commodity assets, wherein the system includes:
(a) an arrangement for maintaining one or more accounts in the value system, wherein the accounts have associated therewith one or more commodity assets;
(b) an arrangement for diminishing or enhancing the one or more commodity assets associated with the one or more accounts in response to payments or receipts respectively into the one or more accounts respectively;
wherein the system for paying payments further includes:
(c) an arrangement for using one or more market makers for relating values of the one or more commodity assets to one or more monetary currencies employed for making the payments or receipts, wherein the one or more market makers have external authorization outside a banking system.

12. The system as claimed in claim 11, wherein the system includes:
(d) the one or more commodity assets implemented as one or more real physical materials; and
(e) the payments or receipts implemented in one or more fiat currencies.

13. The system for making payments as claimed in claim 11, wherein the system for making payments further includes:
(f) an arrangement in the value system for making the payments or receipts via use of a personal credit card or debit card.

14. The system for making payments as claimed in claim 12, wherein the system includes:
(g) an arrangement for enabling the system to support use of the personal credit card or debit card, wherein the personal credit card or debit card is RFID-enabled and/or chip-enabled for authentication purposes.

15. The system for making payments as claimed in claim 14, wherein the system includes:
(h) an arrangement for enabling use of the personal credit card or debit card in one or more ATM's and/or one or more POS terminals.

16. The system for making payments as claimed in claim 11, wherein the system includes an arrangement for using the one or more market makers in real time when the payments or receipts for relating values of the one or more monetary currencies to the one or more commodity assets.

17. The system for making payments as claimed in claim 11, wherein the system includes an arrangement for implementing the one or more commodity assets to include at least one of: base metals, minerals, noble metals Gold, Silver, rare Earth materials, hydrocarbon fuel products and/or raw materials.

18. The system as claimed in claim 11, wherein the system includes an arrangement for the value system to provide information to its one or more users associated with the one or more accounts, wherein the information includes an indication of the one or more commodity assets expressed in at least one of: weight, volume, numbers of physical elements, a real-time monetary market value of the one or more commodity assets.

19. The system as claimed in claim 11, wherein the system includes an auditing arrangement for auditing transactions executed by the one or more market makers by employing an independent auditing arrangement.
